(19) United States
(12) Patent Application Publication
(10) Pub. No.: US 2006/0143295 A1
(43) Pub. Date: Jun. 29, 2006

(54) System, method, mobile station and gateway for communicating with a universal plug and play network

(75) Inventors: Jose Costa-Requena, Helsinki (FI); Inmaculada Espigares, Helsinki (FI); Kirmo Koistinen, Oulu (FI); Kari Kaarela, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/022,736

(22) Filed: Dec. 27, 2004

(51) Int. Cl. G06F 15/16

(52) U.S. Cl. 709/227

(57) ABSTRACT

Methods and systems are provided to link two Universal Plug and Play (“UPnP”) networks to enable the devices in one to communicate directly with the devices in the other. Specifically, a mobile station visiting a first UPnP network may establish communication with a second UPnP network via Web Services (“WS”) protocol with a network gateway of the second UPnP network. The UPnP devices in the first UPnP network can then communicate with those in the second. According to another aspect, a secure communication link is provided between the UPnP network and the remotely located mobile station. Specifically, a network gateway acts as an entry point to the UPnP network and authenticates and authorizes messages from the mobile station. According to yet another aspect, a mobile station lacking UPnP capabilities can communicate with UPnP devices using a network gateway that converts between WS messages and UPnP commands.

### FIELD OF THE INVENTION

The present invention relates generally to networking, and more particularly, to the networking of devices using a Universal Plug and Play (hereinafter “UPnP”) architecture, such that a mobile station outside of a UPnP network can communicate with devices within the UPnP network.

### BACKGROUND OF THE INVENTION

Universal Plug and Play (UPnP) is a network architecture that enables the peer-to-peer network connectivity of devices including personal computers (PCs), intelligent machines, appliances, wireless devices, and the like. UPnP allows peripheral devices from a wide range of vendors to discover and connect to other devices over a zero-configuration, “invisible” network. Once connected, any two devices in the network are capable of communicating with one another under the command of a control device in the UPnP network.

According to the UPnP architecture, a UPnP device dynamically joins a network, obtains an IP address, announces its name to the network, conveys its capabilities upon request, and learns about the presence and capabilities of other UPnP devices in the network. UPnP leverages Internet components, including IP, TCP, UDP, HTTP, and XML to enable seamless proximity networking. UPnP networks are quite versatile and can communicate via any media including both wireline and wireless communications. In addition, UPnP devices that use any programming language on any operating system (OS) can communicate with other UPnP devices via the UPnP network.

UPnP is used primarily in homes, small businesses and commercial buildings. Using UPnP technology, devices can be controlled remotely, digital data in the form of audio, video, or still images can be transferred between devices, and information can be shared between devices, just to name a few applications. For example, using UPnP technology, music files can be accessed from various devices in a home without regard to where the files are stored.

In order to function properly, multi-vendor collaboration is necessary for establishing standard Device Control Protocols (DCPs). To that end, the UPnP Forum was established. The UPnP Forum consists of over 720 vendors committed to overseeing the establishment of UPnP specifications, protocols, etc. Members of the UPnP Forum define and publish UPnP device and service descriptions in order to create the means to easily connect devices and simplify the implementation of networks.

A drawback of the UPnP architecture is that it is limited to the networking of UPnP devices that are in close proximity of each other, e.g., in a home or an office building. While current technology enables a user to access these devices from remote locations, access is limited to merely communicating using basic HTTP-protocols or via a browser launched by a remote device. For example, consider the scenario in which a person attending a party at a friend's home wishes to play a song that the friend does not have, but that the visitor has saved on a media server in his home UPnP network. Under the current technology, the visitor would first have to download the music from his media server onto his mobile phone and then stream the music from his mobile phone over the remote UPnP network located at the friend's home to the friend's stereo. While effective, this approach requires significant user interaction and may have security concerns because of the unsecure communication established between the mobile station and the home UPnP network.

While it may be more efficient to allow the friend's stereo in the remote UPnP network to communicate directly with the media server in the home UPnP network, there currently exists no known means for linking the two UPnP networks so that the devices in the remote UPnP network can be accessed as if they were part of the home UPnP network, and vice versa. In terms of the foregoing example, current technology does not allow the visitor to stream the music directly from his home media server to his friend's home stereo. A need, therefore, exists for technology that will enable the linking of two UPnP networks, i.e., a remote UPnP network and a home UPnP network, such that the devices in one are available to the devices in the other, as if they were part of one UPnP network.

Establishing a remote connection with a UPnP network raises certain security concerns. These concerns are increased when multiple UPnP networks are configured to communicate with one another. For example, because of the potential for signals to be altered during transmission, one may have security concerns regarding the integrity of messages being transmitted. In addition, a concern may arise with regard to the illegitimate accessing of the UPnP network. A need, therefore, exists for a secure communication link to the UPnP network from a device outside the UPnP network and further between two UPnP networks.

A further drawback of the current UPnP technology is the requirement that each device that wishes to join or communicate with a UPnP network be capable of communicating via UPnP commands. While many devices can do this, some cannot and therefore cannot participate in UPnP networks. A need, therefore, exists for isolating UPnP technology from a device, while enabling that device to nonetheless join and communicate with a UPnP network.

### BRIEF SUMMARY OF THE INVENTION

Generally described, embodiments of the present invention provide an improvement over the known prior art by providing the technology by which UPnP devices in a local UPnP network can become visible to a remote UPnP network, and vice versa. Embodiments of the present invention further provide an improved technique for accessing a home UPnP network from a remote location such as via a secure communication link. In addition, other embodiments of the present invention provide for isolating UPnP technology from devices connected to and communicating with a UPnP network.

In one aspect of the present invention a system is provided for linking two UPnP networks that are remotely located, such as a home UPnP network and a visited UPnP network. According to this embodiment, the UPnP devices in the home UPnP network are able to communicate with the UPnP devices in the visited UPnP network, and vice versa, via a mobile station and a home network gateway. The mobile station is, at least temporarily, visiting the visited UPnP network, and is in communication with the UPnP devices in the visited UPnP network. By contrast, the home network gateway is in communication with and in partial control of the UPnP devices in the home UPnP network. By communicating with the home network gateway, therefore, the mobile station is able to provide a communication link between the devices in the two UPnP networks.

According to this embodiment, the mobile station and the home network gateway communicate with each other according to Web Services (“WS”) protocol. By contrast, the UPnP devices in the home UPnP network communicate with each other, and with the home network gateway using UPnP commands. Similarly, the UPnP devices in the visited UPnP network communicate with each other and with the mobile station using UPnP commands. The mobile station and the home network gateway, therefore, convert between WS messages and UPnP commands in order to facilitate communication between the UPnP devices in the two networks.

In another aspect of the present invention, a system is provided for communicating with a UPnP network from a remote location over a secure channel. According to this embodiment, a web proxy gateway is configured as an entry point to a UPnP network for communications from a mobile station. As in the previous embodiment, the mobile station and the web proxy gateway communicate according to WS protocol, while the UPnP devices in the UPnP network communicate with each other and with the web proxy gateway using UPnP commands. Accordingly, the web proxy gateway converts between WS messages and UPnP commands. In addition, the web proxy gateway authenticates and authorizes messages received from the mobile station that are intended for at least one UPnP device in the UPnP network. In one embodiment the mobile station and the web proxy gateway communicate via messages encrypted with shared secret keys.

In one embodiment of the present invention after converting the WS messages received from the mobile station into UPnP commands, the web proxy gateway further encrypts the UPnP commands prior to communicating them to the UPnP device for which they were intended. In one embodiment, the web proxy gateway uses a private encryption key allocated to it from a dedicated security device in the UPnP network to encrypt the UPnP command. In this embodiment, the UPnP device that receives the UPnP command will then use the web proxy gateway's public encryption key to decrypt the UPnP command and verify that it was in fact the web proxy gateway that communicated the UPnP command to it.

An advantage of at least one embodiment of the present invention is that a mobile station can communicate with a UPnP network without possessing the UPnP technology necessary to communicate via UPnP commands. According to one embodiment, a network gateway is provided for enabling communication with a UPnP network for a mobile station that lacks UPnP technology. Specifically, in one embodiment of the present invention a mobile station that is operating only a thin application void of UPnP technology can communicate with the UPnP devices in a UPnP network by communicating with a network gateway according to WS protocol. The network gateway, which is in communication with and partial control of the UPnP devices in the UPnP network, is able to convert the WS messages received from the mobile station into UPnP commands for communicating to at least one UPnP devices in the UPnP network.

Other objects, features, and advantages of the present invention will become apparent upon reading the detailed description of the preferred embodiments of the invention below taken in conjunction with the drawings and the appended claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates two UPnP networks communicating with one another according to one embodiment of the present invention;

FIG. 2 is a schematic block diagram of a mobile station capable of operating in accordance with an embodiment of the present invention;

FIG. 3 is a schematic block diagram of a home network gateway used in one embodiment of the present invention to provide a connection to a UPnP network for a remote mobile station;

FIG. 4 is a flow chart illustrating the steps necessary to create a link between two UPnP networks in accordance with one embodiment of the present invention;

FIG. 5 illustrates a secure communication link to a UPnP network from a remote location according to one embodiment of the present invention;

FIG. 6 is a schematic block diagram of a web proxy gateway used in communicating with a UPnP network from a remote location over a secure communication link in one embodiment of the present invention; and

FIG. 7 is a flow chart illustrating the steps necessary to communicate with a UPnP network from a remote location over a secure communication link according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The systems and methods of the present invention support communication with a UPnP network from a remote location, either from a mobile station or from UPnP devices in a remote UPnP network. One embodiment of the present invention provides a system in which the devices in a first UPnP network, such as a home UPnP network, become visible to a second UPnP network, such as a remote UPnP network, through a mobile station that is at least temporarily part of the second UPnP network. It will be understood by those of skill in the art that the devices in a UPnP network can include, but are not limited to, personal computers, laptop computers, gaming systems, televisions, stereos, cameras, appliances, other consumer electronic and computer products, and the like. It will further be understood that the term “mobile station” can refer to a mobile phone, pager, handheld data terminal, personal data assistant (PDA), or other handheld mobile electronic device capable of wireless communication.

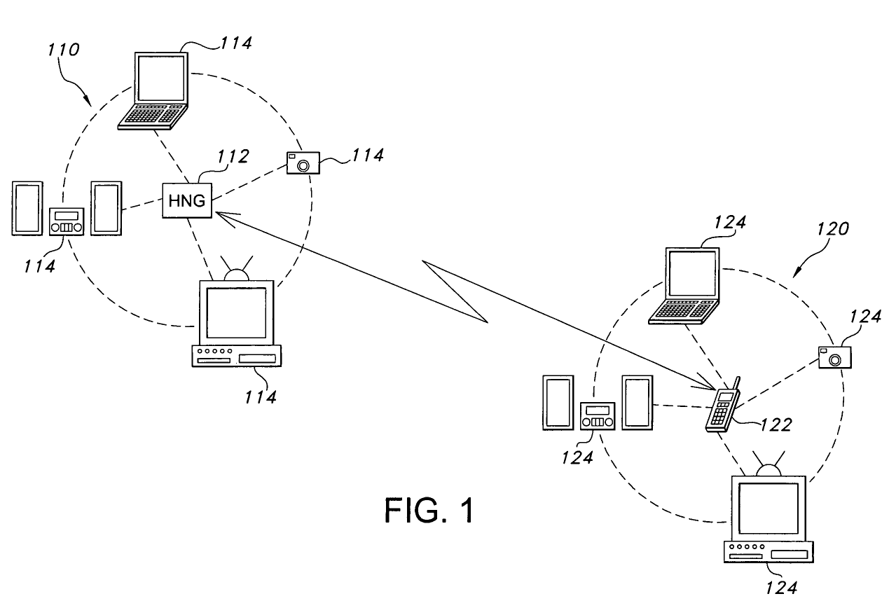

FIG. 1 illustrates two UPnP networks located remotely from each other communicating with one another in accordance with Web Services (WS) protocol. As will be understood by those of skill in the art, WS protocols include Internet protocols, such as SOAP (Simple Object Access Protocol), that may be provided by an HTTP (Hypertext Transfer Protocol) transport layer to provide connectivity and interoperability between the networks. As will be appreciated by those skilled in the art, the SOAP architecture provides a manner of encapsulating messages in envelopes, sometimes referred to as SOAP messages or SOAP envelopes, which can then be transferred from one network entity to another over a bearer protocol, such as HTTP. In this regard, information in the encapsulated messages can be formatted in any of a number of different manners, such as in accordance with RDF (Resource Development Framework) or XML (Extensible Markup Language). For more information on SOAP, see D. Box et al., Simple Object Access Protocol V1.1, W3C Note NOTE-soap-20000508, World Wide Web Consortium (2000), the contents of which are hereby incorporated by reference in its entirety.

As shown in FIG. 1, in one embodiment of the present invention, a user who is visiting a remote UPnP network 120 can communicate with his home UPnP network 110 from the remote location using his/her mobile station 122. Prior to communicating with the home UPnP network 110, the mobile station 122 sends a message to the remote UPnP network 120 indicating its presence in the network and requesting the identities and capabilities of the devices in the remote UPnP network 124. Once the mobile station 122 is part of the remote UPnP network 120 and is in communication with the other devices in the remote UPnP network 124, the user can then use the mobile station 122 to communicate with the home UPnP network 110. In this embodiment, the mobile station 122 may include a processing device capable of executing a remote gateway client application stored in memory on the mobile station to communicate with the home UPnP network 110 and, more particularly, with a home network gateway 112 in communication with the home UPnP network 110. The home network gateway 112 in turn communicates with the other devices in the home UPnP network 114, as described below.

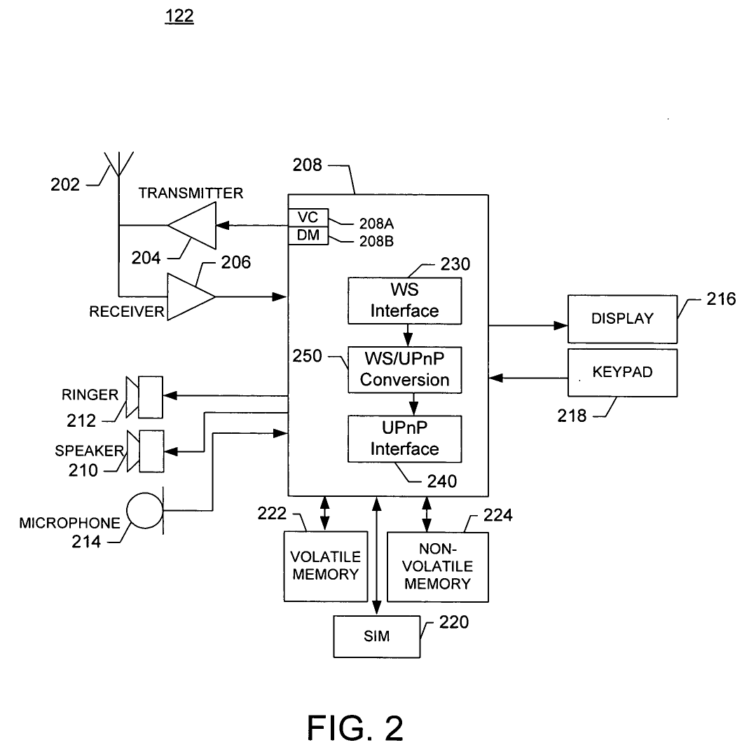

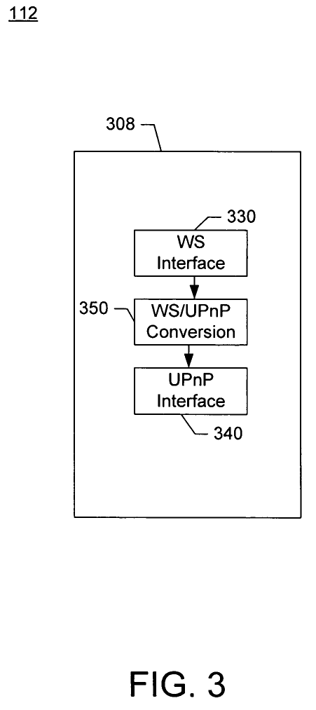

As shown in more detail in FIGS. 2 and 3, respectively, according to one embodiment of the present invention, the mobile station and the home network gateway each include at least one processing device or controller 208, 308. Each further includes a WS interface 230, 330 for receiving and transmitting messages via WS protocol, a UPnP interface 240, 340 for receiving and transmitting UPnP commands, and a WS/UPnP converter 250, 350 for converting between the two, all of which are generally comprised by the respective processing device 208, 308. Specifically, in an embodiment of the present invention, a mobile station 122 and the home network gateway 112 each communicate with respective UPnP networks 120, 110 using UPnP commands. Advantageously, each can communicate with the other via WS protocols. Thus, the mobile station 122 and the home network gateway 112 both provide UPnP & WS gateway functionality. Specifically, each device is capable of converting UPnP commands issued by UPnP devices 114, 124 in the UPnP network 110, 120 and intended for a remote device, such as a UPnP device 114, 124 in another UPnP network 110, 120, into corresponding WS messages and transmitting those messages to the other device. Each is further capable of converting WS messages issued by the other and intended for a UPnP device in the UPnP network with which it is associated into UPnP commands and transmitting those commands to the UPnP device for which they were intended. The home network gateway 112 also has full control point functionality over devices in the home UPnP network 114. In other words, the home network gateway 112 communicates with and controls, to some extent, all of the devices in the home UPnP network 114. By communicating with the home network gateway 112, therefore, the mobile station 122 is able to communicate with the other devices in the home UPnP network 114.

In addition, in one embodiment, the home network gateway 112 also possesses rendering functionality. In other words, the home network gateway 112 is able to produce graphic images on a media output device, such as a video display or printer, located in either the home or remote UPnP network 110, 120. For example, in the instance where a user wishes to stream audiovisual (AV) media from a local media server in the home UPnP network 110 to a media output device in the remote UPnP network 120, the home network gateway 112 first begins a rendering session with the local media server during which it receives the media data from the local media server. The home network gateway 112 then transmits the media data to the appropriate output device in the remote UPnP network 120 via the mobile station 122. In one embodiment, the home network gateway 112 transmits the media data as a standard HTTP or Real-Time Protocol (RTP) file, rather than as a WS message.

The home network gateway 112 may be located in the Internet Gateway Device (IGD), which may be a standalone device located either outside of or in the UPnP network. Alternatively, the home network gateway 112 may be embedded in one of the other UPnP devices in the network 114, such as a personal computer.

The mobile station 122, shown in FIG. 2, includes an antenna 202, a transmitter 204, a receiver 206, and a controller 208 that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed above. For example, the processing device may be comprised of a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise a user interface such as including a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include memory, such as a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for enabling the mobile station to communicate with a home network gateway of a home UPnP network in order to identify UPnP devices in the home UPnP network, to communicate with devices in a remote UPnP network in order to announce the home UPnP devices to the remote UPnP network, and to support communications between home and remote UPnP devices.

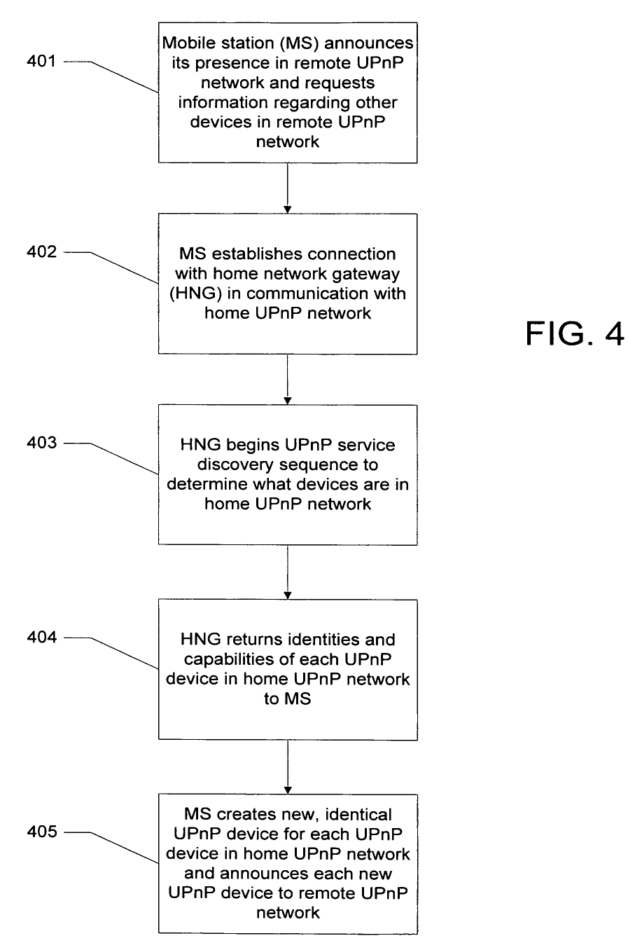

FIG. 4 is a flow chart illustrating the steps involved in linking two UPnP networks 110, 120 using a mobile station 122 and a home network gateway 112 as described above, wherein the mobile station 122 is in communication with a remote UPnP network 120, while the home network gateway 112 is in communication with a home UPnP network 110. In Step 401, the mobile station 122 announces its presence in the remote UPnP network 120 and requests information regarding the other devices in the remote UPnP network 124. Once the mobile station 122 is part of the remote UPnP network 120, in Step 402, the user employs a remote gateway client application, which can be embodied by computer program code stored by memory and executed by the processing device 208 of the mobile station 122, to establish a connection to the home network gateway 112, which is in communication with the UPnP devices in the home UPnP network 114. In response to the establishment of this connection, in Step 403, the home network gateway 112 begins a UPnP service discovery sequence to determine what devices are in the home UPnP network 110 and what the capabilities and services of those devices 114 are. In Step 404, the home network gateway 112 returns the identities and capabilities of each UPnP device in the home UPnP network 114 to the mobile station 122. As noted above, communication between the mobile station 122 and the home network gateway 112 is in accordance with WS, while communication within UPnP networks 110, 120 is via UPnP commands, such that the mobile station 122 and the home network gateway 112 make appropriate conversions between WS messages and UPnP commands. Finally, in Step 405, the mobile station 122 creates a new, identical UPnP device for each UPnP device in the home UPnP network 114 and announces each new UPnP device to the remote UPnP network 120. To the UPnP devices that are actually present in the remote UPnP network 124, the new UPnP devices are identified so as to all appear as one physical device, i.e., the mobile station 122. This permits all communication with the new UPnP devices to be routed through the mobile station 122 while still identifying the particular UPnP device involved in the communication. Once the mobile station 122 has created the UPnP devices in the remote UPnP network 120, the devices in the two UPnP networks, home 110 and remote 120, can communicate with one another through the connection established between the mobile station 122 and the home network gateway 112 as if they were part of one overall UPnP network.

To illustrate, recall the scenario where a person attends a party at a friend's home and wishes to play a song that the friend does not have, but that the visitor has saved on a media server in his home UPnP network. According to an embodiment of the present invention, the visitor would first use his mobile station, e.g., his cell phone, to transmit a UPnP command to the UPnP network located at his friend's home, indicating the cell phone's presence in the friend's UPnP network and requesting information about the other devices in the network. Once the cell phone has established communication with the devices in the friend's UPnP network, the visitor would then use his cell phone to send a WS message to the home network gateway connected to his home UPnP network. The home network gateway would then begin a UPnP service discovery sequence and return to the cell phone the identities and capabilities of the devices in the home UPnP network. The cell phone could then create new, identical UPnP devices and announce each new UPnP device to the friend's UPnP network. A UPnP device in the friend's UPnP network, such as a stereo or PC, would then be able to communicate directly with the media server in the home UPnP network via the cell phone and the home network gateway in order broadcast songs stored in the media server. This system provides an advantage over the current technology, wherein the visitor would be required to download the music onto his cell phone and then stream the music over his friend's UPnP network to the friend's stereo or PC, because it is more efficient and requires less user interaction.

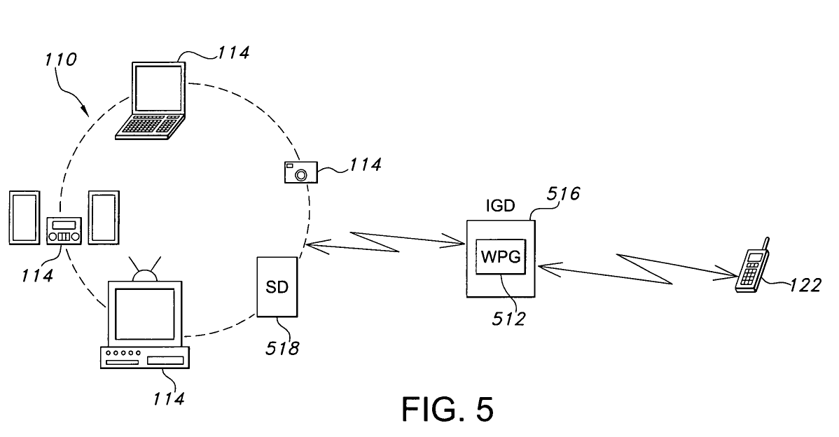

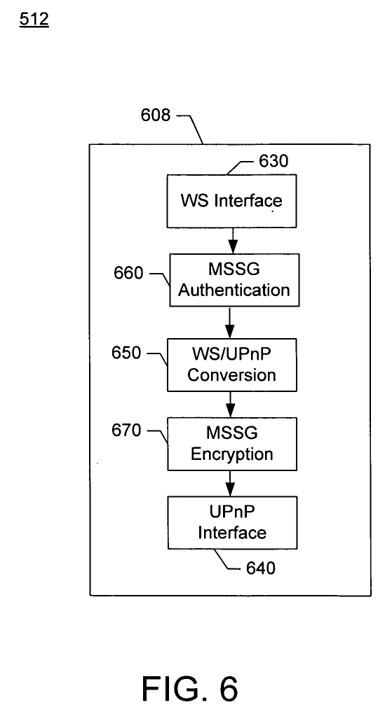

FIG. 5 illustrates another embodiment of the present invention wherein a secure communication channel, such as a virtual private network (VPN) tunnel, is established between the home UPnP network 110 and a remotely located mobile station 122. As shown, a remote mobile station 122 connects to the home UPnP network 110 over a secure communication link established with a web proxy gateway 512. In one embodiment, the web proxy gateway 512 may be the home network gateway 112, as described above. While FIG. 5 depicts the web proxy gateway 512 as being outside the UPnP network, such as in an IGD 516, it will be understood by those of skill in the art that the web proxy gateway 512 may also be embedded in a UPnP device located in the home UPnP network 114, such as a PC. According to one embodiment of the present invention, a web proxy gateway 512, shown in more detail in FIG. 6, is defined as an entry point to the home UPnP network 110. As the entry point, the web proxy gateway 512 serves at least four functions. First, the web proxy gateway 512 is accessible via the Internet, and after authenticating the mobile station 122, discussed in detail below, the web proxy gateway 512 provides a Web page wherein all of the UPnP devices 114 in the home UPnP network 110 are represented. For example, the Web page may include one or more icons representing each of the different UPnP devices 114. This allows the user to select the specific UPnP device (e.g., by clicking on the icon on the Web page that represents that device) to which he or she wishes to connect. This procedure provides for (i) the authentication of a user with access rights to a specific device, and (ii) the establishment of a specific VPN policy that allows the user's mobile station to establish a secure channel with only that specific device.

Second, the web proxy gateway 512 provides the necessary conversions between the UPnP commands with which the UPnP devices 114 communicate in the home UPnP network 110 and the WS messages transmitted to and from the remote mobile station 122, similar to the functionality of the home network gateway 112 described above. To that end, the web proxy gateway 512 includes at least one processing device 608 that supports or provides a WS interface 630 for receiving and transmitting messages via WS protocols, a UPnP interface 640 for transmitting and receiving UPnP commands, and a WS/UPnP converter 650 for converting between the two. In another, alternative embodiment of the present invention, the web proxy gateway 512 acts as a UPnP proxy wherein UPnP messages, rather than WS messages, are sent directly from the mobile station 122 to the UPnP device 114 in the home UPnP network 110 through the web proxy gateway 512, which acts as a relay over the VPN connection.

Third, the web proxy gateway 512 acts as a secure gateway to the home UPnP network 110. Specifically, the web proxy gateway 512 includes a message authentication module 660, generally also embodied by the processing device 608, that performs message authentication and authorization. The web proxy gateway 512 may provide the authentication and authorization in various manners. In one embodiment, the messages are transmitted between the mobile station 122 and the web proxy gateway 512 in accordance with shared secret, i.e., encrypted in accordance with a key maintained by both the mobile station 122 and the web proxy gateway 512. Alternatively, the mobile station 122 and the web proxy gateway 412 may utilize other security mechanisms, such as that defined by the Liberty specifications provided by the Liberty Alliance (www.projectliberty.org), with the web proxy gateway 512 providing Liberty proxy functionality, or a mobile operator authentication procedure based on Authentication and Key Agreement (AKA). Finally, the web proxy gateway 512 also acts as a Control Point wherein it receives UPnP announcements from all of the UPnP devices 114 in the home UPnP network 110 and maps them into a Web page that can be accessed by the user from an external network.

In order to further secure the communication within the home UPnP network 110, in one embodiment of the present invention a security mechanism, such as one based on public key infrastructure (PKI), is also implemented locally in the home UPnP network 110. PKI is a cryptographic system wherein a pair of keys is used for encryption. Specifically, a public key encrypts data, while a private key is used to decrypt it. For digital signals, however, the process is reversed: the sender uses the private key to encrypt the signal, which is then decrypted by the receiver using the public key. According to one embodiment, a dedicated UPnP device 518, such as a gateway, PC or secure console, may provide this security mechanism. This dedicated security device 518 will be announced as security services to the home UPnP network 110 and will generate server certificates for the other devices in the home UPnP network 114, typically automatically following the announcement. The security device 518 may provide these certificates to the UPnP devices, or, in the alternative, it may keep the certificates and make them available to the UPnP devices upon request. In one embodiment, in order to securely communicate within the home UPnP network, a first device in the home UPnP network 114 will request the certificate of a second device with which it desires to communicate from either the security device 518 or the second device itself. The first device can then query the security device to determine whether the certificate is valid. In response, the second device may also request and verify the validity of the first device's certificate. Alternatively, each UPnP device 114 in the home UPnP network 110 may provide the other devices in the network with its certificate initially, rather than waiting until a desire to communicate arises, in order to enable future communication between the devices.

For example, in an embodiment where the security mechanism used is PKI, and the signals being transmitted are digital, a dedicated security device 518 may provide each UPnP device in the home UPnP network 114 with a server certificate containing both a public and a private encryption key. Each UPnP device 114 distributes its public key to the UPnP devices in the home UPnP network 114 with which it wishes to communicate. The UPnP device 114 then uses it private key to encrypt a message and transmit it to another UPnP device 114 in the network. The UPnP device 114 receiving the message can then use the public key previously received from the transmitting UPnP device 114 to decrypt the message and verify that the message was truly sent by the transmitter. In one embodiment of the present invention, the web proxy gateway 512 is the transmitting UPnP device. According to this embodiment, a message encryption module 670 of the web proxy gateway 512, which is generally embodied by computer program code stored by memory and executed by the processing device 608, encrypts the UPnP command corresponding to a WS message received from the mobile station 122 using the web proxy gateway's 512 private key prior to transmitting the UPnP command to a UPnP device in the home UPnP network 114. The receiving UPnP device can then use the web proxy gateway's 512 public key to decrypt the UPnP command and verify that it was the web proxy gateway 512 that sent it.

In another embodiment of the present invention, the certificates are self-generated by each UPnP device, rather than by a dedicated security device. This embodiment utilizes a security feature that is currently embodied in UPnP technology. Current UPnP technology includes the distribution of a secret token to each UPnP device when a user purchases it. The user then uses the secret token to generate a password for accessing the device. According to one embodiment of the present invention, this UPnP security feature is used to create the home PKI, whereby each UPnP device automatically generates its own certificate using the secret token at the moment the user installs the device and configures access rights to it. In one embodiment, each UPnP device distributes its certificate to the other devices in the UPnP network. Alternatively, in another embodiment, a dedicated security device in the UPnP network collects the certificates and makes them available for validation to the devices that wish to interact.

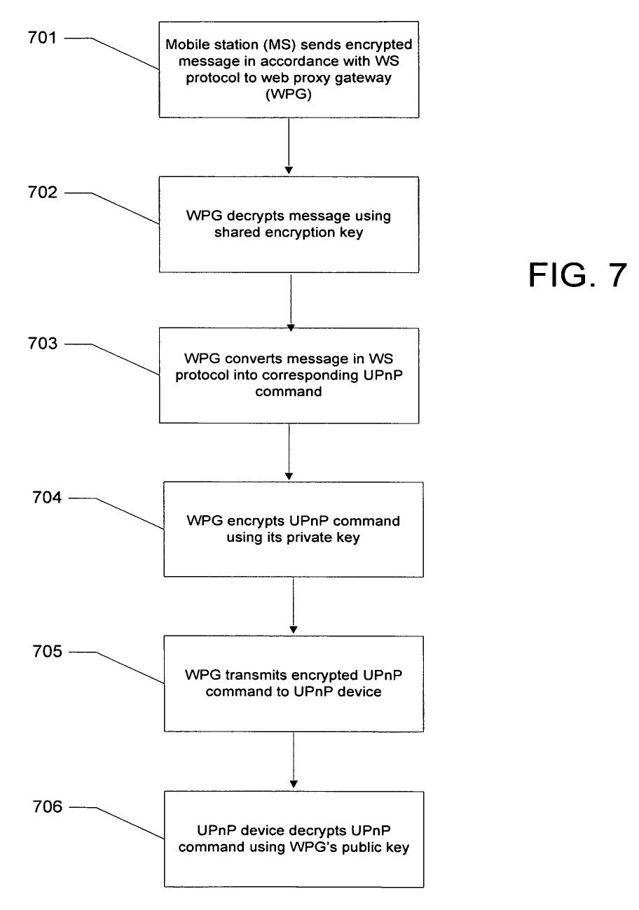

FIG. 7 is a flow chart illustrating the steps involved in providing a secure communication link within a home UPnP network 110 and to the home UPnP network 110 from a remote location according to one embodiment of the present invention. In the first step, Step 701, a mobile station 122 sends an encrypted message in accordance with WS protocol to the web proxy gateway 512. Next, in Step 702, the web proxy gateway 512 decrypts the message, for example using a shared encryption key known to both the web proxy gateway 512 and the mobile station 122. In decrypting the message, the web proxy gateway 512 is able to authenticate the message and authorize its transmittance to the home UPnP network 110. In Step 703, the web proxy gateway 512 converts the message in the WS protocol into a corresponding UPnP command. The web proxy gateway 512 then, in Step 704, encrypts the UPnP command, for example based on a server certificate and a private encryption key provided to the web proxy gateway 512 by the dedicated security device 518. Finally, in Step 705, the web proxy gateway 512 transmits the encrypted UPnP command to the appropriate UPnP device 114, which can then, in Step 706, use the public encryption key of the web proxy gateway 512 to decrypt the message.

By permitting a mobile station 122 to communicate with UPnP devices in a home UPnP network 114 via WS, it is no longer necessary for the mobile station 122 to possess UPnP functionality. The mobile station 122 need not be capable of communicating via UPnP commands. In contrast to the embodiments discussed above, wherein the mobile station 122 was used to link two UPnP networks 110, 120, which required that the mobile station 122 possess both UPnP and gateway functionality, in the situations in which a mobile station 122 is communicating directly with the devices in one UPnP network via WS, the mobile station 122 employed can operate using only a thin application that does not include UPnP technology. It need not possess either UPnP or gateway functionality. This provides the advantage of allowing more versatile devices to communicate with a UPnP network. It further eliminates the risks inherent with incorporating UPnP technology, which may be owned and/or controlled by others, in the mobile stations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for linking home and visited universal plug and play (“UPnP”) networks comprising:
a home UPnP network comprising one or more home UPnP devices;
a visited UPnP network comprising one or more visited UPnP devices;
a home network gateway in communication with said home UPnP network; and
a mobile station in communication with said visited UPnP network and configured to concurrently communicate with said home network gateway and to cooperate with said home network gateway to identify said one or more home UPnP devices to said one or more visited UPnP devices such that said one or more visited UPnP devices are capable of communicating with said one or more home UPnP devices via said mobile station and said home network gateway.

2. The system of claim 1 wherein said mobile station and said home network gateway communicate with each other according to Web Services (“WS”) protocol.

3. The system of claim 2 wherein said one or more home UPnP devices communicate with one another and with said home network gateway using UPnP commands, and said one or more visited UPnP devices communicate with one another and with said mobile station using UPnP commands.

4. The system of claim 3 wherein said home network gateway comprises at least one processing device capable of converting messages received from said mobile station in accordance with WS protocol to corresponding UPnP commands for communicating to at least one of said one or more home UPnP devices, and wherein said mobile station comprises at least one processing device capable of converting messages received from said home network gateway in accordance with WS protocol to corresponding UPnP commands for communicating to at least one of said one or more visited UPnP devices.

5. A system for linking two universal plug and play (“UPnP”) networks remotely located comprising:
a first UPnP network comprising one or more first UPnP devices;
a first network gateway configured to communicate with and control said one or more first UPnP devices;
a second UPnP network comprising one or more second UPnP devices; and
a mobile station gateway configured to communicate with said one or more second UPnP devices, wherein said first network gateway and said mobile station gateway communicate according to Web Services (“WS”) protocol, and wherein said first network gateway converts messages from said mobile station gateway in accordance with WS protocol to corresponding UPnP commands for communicating to at least one of said one or more first UPnP devices.

6. The system of claim 5 wherein said mobile station gateway converts messages from said first network gateway in accordance with WS protocols to corresponding UPnP commands for communicating to at least one of said one or more second UPnP devices.

7. The system of claim 6 wherein said one or more first UPnP devices and said one or more second UPnP devices can communicate with each other via said mobile station and said first network gateway.

8. A mobile station configured to make one or more home UPnP devices in a home universal plug and play (“UPnP”) network available to one or more visited UPnP devices in a visited UPnP network comprising:
a processing device capable of communicating with a home network gateway in communication with said home UPnP network to identify said one or more home UPnP devices, said processing device also capable of communicating with said visited UPnP network to identify said home UPnP devices to said one or more visited UPnP devices, and said processing device further capable of supporting communication between said home and visited UPnP devices.

9. The mobile station of claim 8 wherein said mobile station communicates with said home network gateway according to Web Services (“WS”) protocol.

10. The mobile station of claim 9 wherein said mobile station communicates with said one or more visited UPnP devices using UPnP commands.

11. The mobile station of claim 10 wherein said mobile station converts between messages in accordance with WS protocol received from and transmitted to said home network gateway and UPnP commands received from and transmitted to at least one of said one or more visited UPnP devices.

12. A method of linking home and visited universal plug and play (“UPnP”) networks comprising:
establishing communication with said visited UPnP network using a mobile station;
contacting a home network gateway in communication with said home UPnP network using said mobile station;
receiving from said home network gateway identities of one or more home UPnP devices in said home UPnP network; and
creating a UPnP device in said visited UPnP network for each UPnP device identified to be in said home UPnP network.

13. The method of claim 12 wherein one or more visited UPnP devices in said visited UPnP network are capable of communicating with said one or more home UPnP devices via said mobile station and said home network gateway.

14. The method of claim 13 wherein said home network gateway and said mobile station communicate according to WS protocol.

15. The method of claim 14 wherein said one or more home UPnP devices communicate with one another and with said home network gateway using UPnP commands, and wherein said one or more visited UPnP devices communicate with one another and with said mobile station using UPnP commands.

16. The method of claim 15 wherein said mobile station and said home network gateway convert between messages in accordance with WS protocol and UPnP commands.

17. A system for communicating with a universal plug and play (“UPnP”) network from a remote location over a secure channel comprising:
a mobile station;
a web proxy gateway configured to communicate with said mobile station over a secure channel and to authenticate and authorize messages communicated there between; and
a UPnP network comprising one or more UPnP devices, said UPnP network configured to communicate with said web proxy gateway.

18. The system of claim 17 wherein said mobile station and said web proxy gateway communicate messages encrypted with shared secret keys via said secure channel.

19. The system of claim 17 wherein said mobile station is configured to communicate with said web proxy gateway in accordance with Web Services (“WS”) protocol, and wherein said web proxy gateway is configured to convert between messages in accordance with WS protocol and UPnP commands for communicating to at least one of said UPnP devices in said UPnP network.

20. The system of claim 19 wherein said mobile station is configured to communicate with said web proxy gateway via SOAP.

21. The system of claim 17 wherein said web proxy gateway is configured to communicate with said UPnP devices of said UPnP network over a secure channel.

22. The system of claim 21 wherein said web proxy gateway and said UPnP devices are adapted to communicate with messages subjected to public key encryption.

23. The system of claim 17 wherein said web proxy gateway and said mobile station establish a virtual private network (“VPN”) to thereby permit VPN tunnels to be established between said home UPnP network and said mobile station.

24. The system of claim 23 wherein said web proxy gateway is capable of presenting a web page to said mobile station including representations of said one or more UPnP devices of said home UPnP network such that the VPN tunnel is established upon selection of one of the UPnP devices represented by the web page.

25. A gateway device configured to establish a secure communication link between a universal plug and play (“UPnP”) network and a mobile station comprising:
a processing device capable of separate communication with one or more UPnP devices in said UPnP network and with said mobile station, and also capable of supporting secure communication there between by authentication and authorization of messages.

26. The gateway device of claim 25 wherein said processing device is capable of encrypting messages intended for said mobile station and decrypting messages received from said mobile station with a shared secret key.

27. The gateway device of claim 25 wherein said processing device is capable of encrypting UPnP commands intended for at least one of said UPnP devices using public key encryption.

28. The gateway device of claim 25 wherein said gateway device communicates with said mobile station according to Web Services (“WS”) protocol.

29. The gateway device of claim 28 wherein said gateway device communicates with said one or more UPnP devices using UPnP commands.

30. The gateway device of claim 29 wherein said gateway device converts between messages in accordance with WS protocol and UPnP commands.

31. A method of accessing a universal plug and play (“UPnP”) network from a remote location over a secure communication link comprising:
receiving a signal transmitted in accordance with Web Services (“WS”) protocol from a mobile station at a web proxy gateway on behalf of a UPnP network;
authenticating said signal;
converting said authenticated signal into a UPnP command; and
transmitting said UPnP command via said UPnP network.

32. The method of claim 31 wherein said web proxy gateway is located on an Internet Gateway Device (“IGD”) outside of said UPnP network.

33. The method of claim 31 wherein said web proxy gateway is embedded in a UPnP device located in said UPnP network.

34. The method of claim 31 wherein said signal received by said web proxy gateway is authenticated using a shared secret key.

35. The method of claim 31 wherein said UPnP command is subject to public key encryption prior to being transmitted via said UPnP network.

36. A system for providing a connection between a mobile station and a universal plug and play (“UPnP”) network comprising:
a mobile station configured to transmit and receive messages in accordance with Web Services (“WS”) protocol;
a UPnP network comprising one or more UPnP devices configured to transmit and receive UPnP commands; and
a network gateway, configured to convert between messages in accordance with WS protocol and UPnP commands to enable said mobile station and said one or more UPnP devices to communicate via said network gateway.

37. The system of claim 36 wherein said mobile station is configured to communicate with said network gateway via SOAP.

38. A gateway device comprising:
a processing device capable of communicating with a mobile station using messages in accordance with Web Services (“WS”) protocol, said processing device also capable of communicating with UPnP devices in a UPnP network using UPnP commands, and said processing device further capable of converting between messages in accordance with WS protocol and UPnP commands.

39. The gateway device of claim 38 wherein said gateway device provides a communication link between said mobile device and said UPnP devices.

40. The gateway device of claim 39 wherein said gateway device is embedded within one of said UPnP devices in said UPnP network.

41. The gateway device of claim 39 wherein said gateway device is located outside of said UPnP network.

42. A method of communicating with a universal plug and play (“UPnP”) network via a remote mobile station comprising:
transmitting messages between a gateway device and a mobile station in accordance with Web Services (“WS”) protocol;
transmitting UPnP commands between said gateway device and one or more UPnP devices in said UPnP network; and
converting between said messages in accordance with WS protocol and UPnP commands.

43. A method of enabling secure communications between one or more universal plug and play (“UPnP”) devices in a UPnP network comprising:
automatically generating a unique security certificate for each of said one or more UPnP devices upon entrance of said UPnP device into said UPnP network, such that a unique security certificate corresponds to each of said one or more UPnP devices, wherein generating the unique security certificate comprises generating the unique security certificate for each UPnP device based upon a secret token issued to the respective UPnP device; and
verifying that said UPnP device is part of said UPnP network based upon the unique security certificate associated with said UPnP device.

44. The method of enabling secure communications of claim 43 wherein generating said unique security certificate comprises generating said unique security certificate with said UPnP device.

45. The method of enabling secure communications of claim 44 further comprising collecting the unique security certificate from each of said one or more UPnP devices in said UPnP network with a dedicated security device also in said UPnP network.

46. The method of enabling secure communications of claim 43 wherein generating said unique security certificates comprises generating said unique security certificates with a dedicated security device also in said UPnP network.
